(19) United States
(12) Patent Application Publication
(10) Pub. No.: US 2016/0007582 A1
(43) Pub. Date: Jan. 14, 2016

(54) LIGHT UP FISHING ROD

(71) Applicant: Amedeo Brancaleoni, Putnam Valley, NY (US)

(72) Inventor: Amedeo Brancaleoni, Putnam Valley, NY (US)

(21) Appl. No.: 14/682,159

(22) Filed: Apr. 9, 2015

Related U.S. Application Data
(60) Provisional application No. 61/977,813, filed on Apr. 10, 2014.

(51) Int. Cl. A01K 87/00; F21V 8/00; F21V 33/00

(52) U.S. Cl. CPC A01K 87/007; F21V 33/008; G02B 6/0001; F21Y 2101/02

(57) ABSTRACT

A fishing pole with features that can cause illumination of the rod tip and the handle area to aid in motion detection caused by a fish.

### CROSS-REFERENCE TO RELATED APPLICATIONS

This application claims the benefit of U.S. Provisional Application No. 61/977,813, filed Apr. 10, 2014.

### BACKGROUND OF THE INVENTION

1. Field of the Invention

The invention is in the field of fishing rods, more particularly, the field of fishing rods containing a means of illumination.

2. Description of the Prior Art

There have been many fishing rods throughout the years. With the advent of fiberglass and new composite materials, fishing rods have become more flexible and now provide higher performance for casting and action of reeling in fish. More recently, fishing rods have incorporated lights, motion sensors, and various increased features.

The present invention incorporates lights within the handle area and/or fishing rod to illuminate the tip of the fishing rod to aid in the detection of motion caused by a fish. In addition, the light in the handle area can serve as a flashlight to facilitate activities such as reading, baiting, and/or seeing objects near the fishing pole.

### SUMMARY OF THE INVENTION

The invention in its present embodiment consists of a light up fishing rod comprising a handle having a sealed waterproof battery compartment that holds at least one battery, a battery cap, at least one rubberized waterproof control switch, at least one source of light, at least one light concentrating light pipe shallow angle funnel, at least one circuit, at least one means to switch at least one source of light, a means to support and/or attach and/or removeably attach a reel, and a rod having at least one eyelet, at least one axially oriented light pipe that both axially transmits light from at least one source of light throughout the length of the rod and at least one means to radially radiate light from at least one location along the axial length of the rod. The battery cap can be a rotating waterproof battery cap. The invention in its present embodiment can additionally comprise at least one gasket. At least one axially oriented light pipe can comprise fiber optics.

The source of light can be at least one first source of light and at least one second source of light. The first source of light can project light axially and the second source of light can project light radially. The circuitry can produce at least two brightness levels of at least one source of light. The light brightness levels can include at least one of the following but not limited to in any order: high, medium, low, off, the ability to dim up and/or down and/or fade between levels, a fast blink, and/or slow blink. The means to radially radiate light from at least one axial light pipe can be ink internally and/or externally applied to the axial light pipe. Another means to radially radiate light from at least one axial light pipe can incorporate at least one irregular surface on the axial light pipe that can be at least one of the following: scored, buffed, molded, stamped, after molded, pressed, created with heat. Another means to radially radiate light from at least one axial light pipe can be caused and/or facilitated by particles and/or objects embedded within and/or onto the axial light pipe. The particles and/or objects can be composed of at least one of the following: reflective materials, solid materials, opaque materials, translucent materials, colored materials, and/or transparent materials with a different index of refraction than that of the axial light pipe. At least one source of light can be at least one of LED, incandescent, laser, florescent, electroluminescent. The LED can be a multicolored LED. The rod can be at least one of the following: transparent, translucent, opaque, coated, painted.

At least one source of light can additionally comprise an adjustable position mechanism. The adjustable position mechanism can be a rotating turret. The adjustable position mechanism can be a rotatable arm that projects light at a multiplicity of angles including but not limited to axially down the length of the rod, radially outward and perpendicular to the axis of the rod, or any intermediate angle in between and/or beyond radially outward and perpendicular to the axis of the rod.

At least one means to switch at least one source of light can comprise a first switch to control at least one first light source and a second switch to control at least one second light source.

The rod can be made from at least one of in whole or in part: fiberglass, composite materials, carbon fiber, wood, metal, plastic, glass, laminated, epoxy, nylon. At least one gasket can be at least one O-ring. The handle can be made from at least one of in whole or in part: foam, cork, rubber, plastic, artificial cork, fiberglass, glass, composite materials, carbon fiber, wood, metal, laminated, epoxy, nylon. The rod and/or handle can float in water. The rod and/or handle can be water resistant and/or waterproof.

The invention can further comprise a removeably attachable stand to support the light up fishing rod.

The rod can further comprise a permanent and/or removeably attachable flag located at or near the tip.

The light up fishing rod can be used for at least one of a variety of uses including but not limited to off shore surf casting, boat poles, ice fishing, tip ups.

Another embodiment of the invention can be a light up fishing rod comprising a handle having a sealed waterproof battery compartment that holds at least one battery, a battery cap, at least one rubberized waterproof control switch, at least one first source of light, at least one second source of light, at least one light concentrating light pipe shallow angle funnel, at least one circuit, at least one means to switch the first source of light and second source of light, a means to support and/or attach and/or removeably attach a reel, and a rod having at least one eyelet, at least one axially oriented light pipe that both axially transmits light from at least one first source of light throughout the length of the rod and radially radiates light from at least one first source of light from at least one location along the axial length of the rod. The battery cap can be a rotating waterproof battery cap. The invention in this other embodiment can additionally comprise at least one gasket. At least one axially oriented light pipe can be and/or comprise fiber optics.

At least one first source of light can project light axially and at least one second source of light can project light radially. The circuitry can produce at least two brightness levels of at least one source of light. The light brightness levels can include at least one of the following but not limited to in any order: high, medium, low, off, the ability to dim up and/or down and/or fade between levels, a fast blink, and/or slow blink. The means to radially radiate light from at least one axial light pipe can be ink internally and/or externally applied to the axial light pipe. Another means to radially radiate light from at least one axial light pipe can incorporate at least one irregular surface on the axial light pipe that can be at least one of the following: scored, buffed, molded, stamped, after molded, pressed, created with heat. Another means to radially radiate light from at least one axial light pipe can be caused and/or facilitated by particles and/or objects embedded within and/or onto the axial light pipe. The particles and/or objects can be composed of at least one of the following: reflective materials, solid materials, opaque materials, translucent materials, colored materials, and/or transparent materials with a different index of refraction than that of the axial light pipe. At least one source of light can be at least one of LED, incandescent, laser, florescent, electroluminescent. The LED can be a multicolored LED. The rod can be at least one of the following transparent, translucent, opaque, coated, painted.

At least one source of light can additionally comprise an adjustable position mechanism. The adjustable position mechanism can be a rotating turret. The adjustable position mechanism can be a rotatable arm that projects light at a multiplicity of angles including but not limited to axially down the length of the rod, radially outward and perpendicular to the axis of the rod, or any intermediate angle in between and/or beyond radially outward and perpendicular to the axis of the rod. At least one means to switch at least one source of light can comprise a first switch to control at least one first light source and a second switch to control at least one second light source.

The rod can be made from at least one of in whole or in part: fiberglass, composite materials, carbon fiber, wood, metal, plastic, glass, laminated, epoxy, nylon. At least one gasket can be at least one O-ring. The handle can be made from at least one of in whole or in part: foam, cork, rubber, plastic, artificial cork, fiberglass, glass, composite materials, carbon fiber, wood, metal, laminated, epoxy, nylon. The rod and/or handle can float in water. The rod and/or handle can be water resistant and/or waterproof.

The invention can further comprise a removeably attachable stand to support the light up fishing rod.

The rod can further comprise a permanent and/or removeably attachable flag located at or near the tip.

The light up fishing rod can be used for at least one of a variety of uses including but not limited to off shore, surf casting, boat poles, ice fishing, tip ups.

Another embodiment of the invention can be a light up fishing rod comprising a handle having a sealed waterproof battery compartment that holds at least one battery, a battery cap, at least one rubberized waterproof control switch, at least one first source of light, at least one circuit, at least one means to switch at least one first source of light and at least one second source of light, a means to support and/or attach and/or removeably attach a reel, and a rod having at least one eyelet, at least one second source of light, and a means to conduct power from at least one circuit to at least one second source of light. The battery cap can be a rotating waterproof battery cap. The invention in this other embodiment can additionally comprise at least one gasket.

At least one second source of light can be at least one LED located at and/or near the tip of the rod. The rod can have a plurality of rod segments interconnectable to one to the other by a connection means, each connection means being operable to interconnect two adjacent rod segments, and having an electrically conductive portion thereof linked to at least one circuit to connect the circuit integrally within the rod portion.

At least one source of light can be at least one first source of light and at least one second source of light. At least one second source of light can project light radially and at least one first source of light can project light radially and/or axially and/or parallel to the axis of the rod. The circuitry can produce at least two brightness levels of at least one first source of light and/or at least one second source of light. The light brightness levels can include at least one of the following but not limited to in any order: high, medium, low, off, the ability to dim up and/or down and/or fade between levels, a fast blink, and/or slow blink.

The rod can further comprise at least one axially oriented light pipe located in at least one portion of the rod that both axially transmits light from at least one second source of light throughout the length of at least a portion of the rod and at least one means to radially radiate light from at least location along the axial length of the rod. At least one second source of light can project light into at least one axially oriented light pipe. The means to radially radiate light from at least one axial light pipe can be ink internally and/or externally applied to the axial light pipe. Another means to radially radiate light from at least one axial light pipe can incorporate at least one irregular surface on the axial light pipe that can be at least one of the following: scored, buffed, molded, stamped, after molded, pressed, created with heat. Another means to radially radiate light from at least one axial light pipe can be caused and/or facilitated by particles and/or objects embedded within and/or onto the axial light pipe. The particles and/or objects can be composed of at least one of the following: reflective materials, solid materials, opaque materials, translucent materials, colored materials, and/or transparent materials with a different index of refraction than that of the axial light pipe. At least one source of light can be at least one of LED, incandescent, laser, florescent, electroluminescent. The LED can be a multicolored LED. The rod can be at least one of the following transparent, translucent, opaque, coated, painted.

At least one source of light can additionally comprise an adjustable position mechanism. The adjustable position mechanism can be a rotating turret. The adjustable position mechanism can be a rotatable arm that projects light at a multiplicity of angles including but not limited to axially down the length of the rod, radially outward and perpendicular to the axis of the rod, or any intermediate angle in between and/or beyond radially outward and perpendicular to the axis of the rod.

At least one means to switch at least one source of light can comprise a first switch to control at least one first light source and a second switch to control at least one second light source.

The rod can be made from at least one of in whole or in part: fiberglass, composite materials, carbon fiber, wood, metal, plastic, glass, laminated, epoxy, nylon. At least one gasket can be at least one O-ring. The handle can be made from at least one of in whole or in part: foam, cork, rubber, plastic, artificial cork, fiberglass, glass, composite materials, carbon fiber, wood, metal, laminated, epoxy, nylon. The rod and/or handle can float in water. The rod and/or handle can be water resistant and/or waterproof.

The invention can further comprise a removeably attachable stand to support the light up fishing rod.

The rod can further comprise a permanent and/or removeably attachable flag located at or near the tip.

The light up fishing rod can be used for at least one of a variety of uses including but not limited to off shore, surf casting, boat poles, ice fishing, tip ups.

In one embodiment of the present invention, the switch can be a soft switch that is waterproof, and located at the end or tip of the handle or rod. A battery holder or caddy, such as a plastic case for batteries, can be used to hold the batteries, which may be AA or AAA. Additionally, a light source may be located near a handle and/or neat the tip of the rod of the present invention. The rod may be clear or see through in areas where the lights are located. The lights used may be LEDS or micro LEDS that can be attached or soldered to a conduit or a wire.

Although preferred embodiments of the present invention have been described it will be understood by those skilled in the art that the present invention should not be limited to the described preferred embodiments. Rather, various changes and modifications can be made within the spirit and scope of the present invention.

### BRIEF DESCRIPTION OF THE SEVERAL VIEWS OF THE DRAWING

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a side cutaway view of the invention with some internal components.

FIG. 2 is a side cutaway view of one embodiment of the invention with LED lights at the tip.

FIG. 3 is a close-up cross-section view of the handle.

FIG. 4 shows some components of the handle.

FIG. 5 shows a cross-section view of components in the handle with two lights.

### DETAILED DESCRIPTION OF THE INVENTION

Detailed descriptions of particular embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

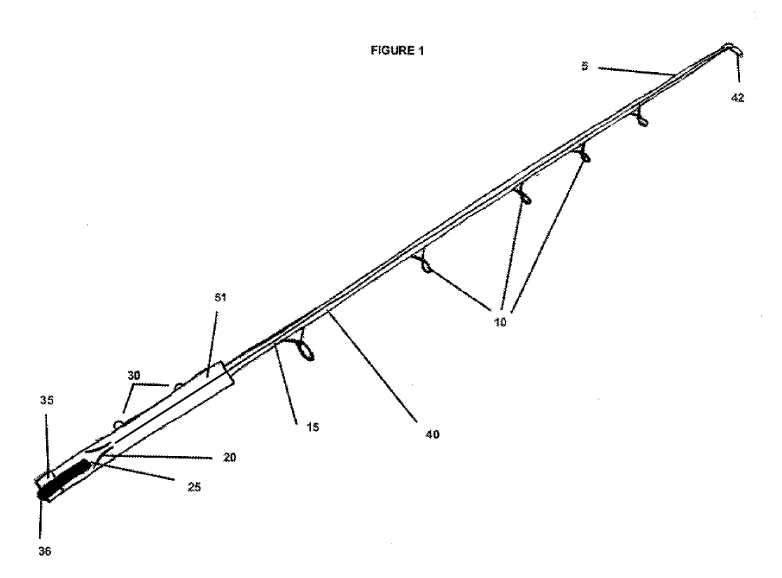

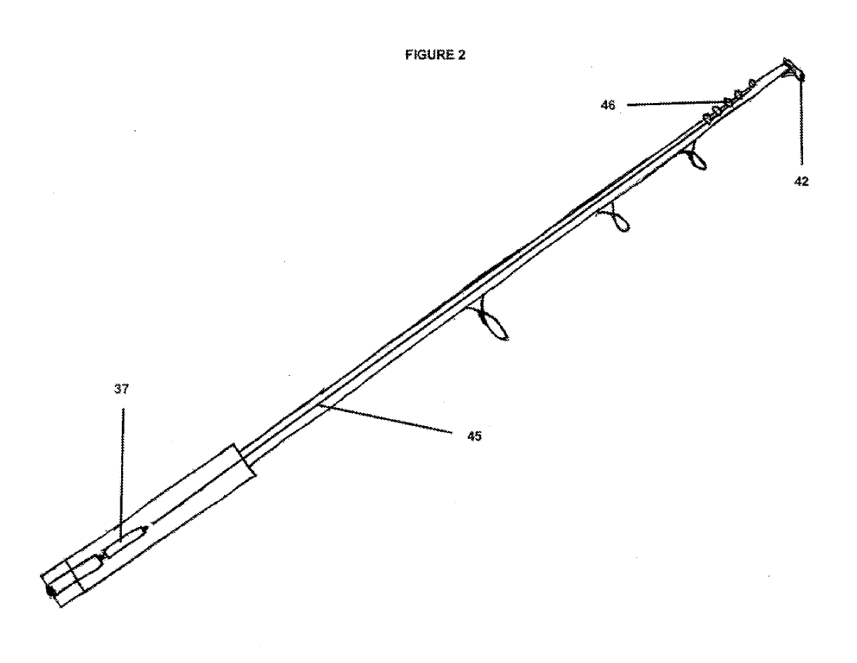

FIG. 1 is a side cutaway view of the invention with some internal components. Shown is the rod 40 on which eyelets 10 are mounted. The handle 51 contains the light source 25, which directs light into the light concentrating light pipe shallow angle funnel 20 that feeds light into the light pipe and/or fiber optics 15. The light pipe and/or fiber optics 15 continues into the body of the rod 40 and terminates at the tip 42 and causes light to radiate from the illuminated end 5. Also on handle 51 is a means to attach reel 30. Within the handle 51 is the battery compartment 37 (shown in FIG. 2). The waterproof battery cap 35 screws onto the end of the handle 51, and the waterproof battery cap 35 also contains a waterproof rubber switch 36.

FIG. 2 is a side cutaway view of one embodiment of the invention with LED end lights 46 at or near the tip 42. In this embodiment, wires 45 pass through the body of the rod 40 (shown in FIG. 1) from the battery compartment 37.

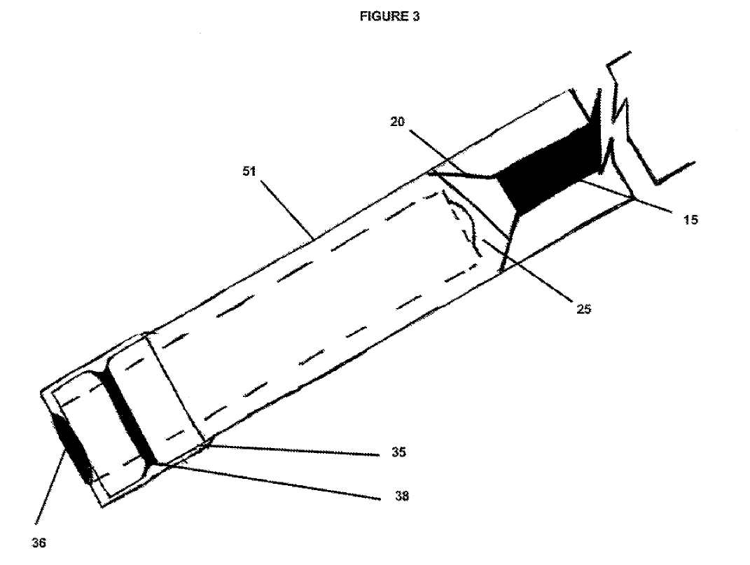

FIG. 3 is a close-up cross-section view of handle 51. The waterproof battery cap 35 creates a waterproof seal with the handle 51 via the O-ring 38. Also shown is the waterproof rubber switch 36. Light source 25 directs light into the light concentrating light pipe shallow angle funnel 20 that feeds light into the light pipe and/or fiber optics 15.

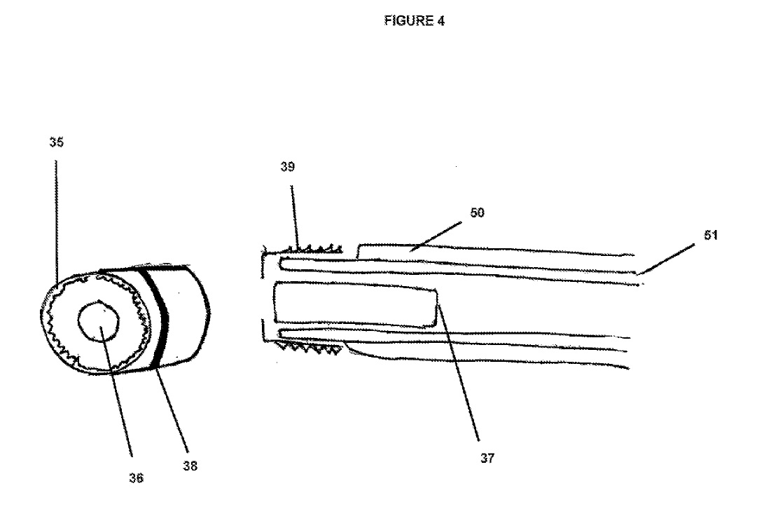

FIG. 4 shows the handle 51, hand grip 50, and threads 39, which secure the waterproof battery cap 35. Also depicted is the waterproof rubber switch 36 and the battery compartment 37. Also depicted is an O-ring 38.

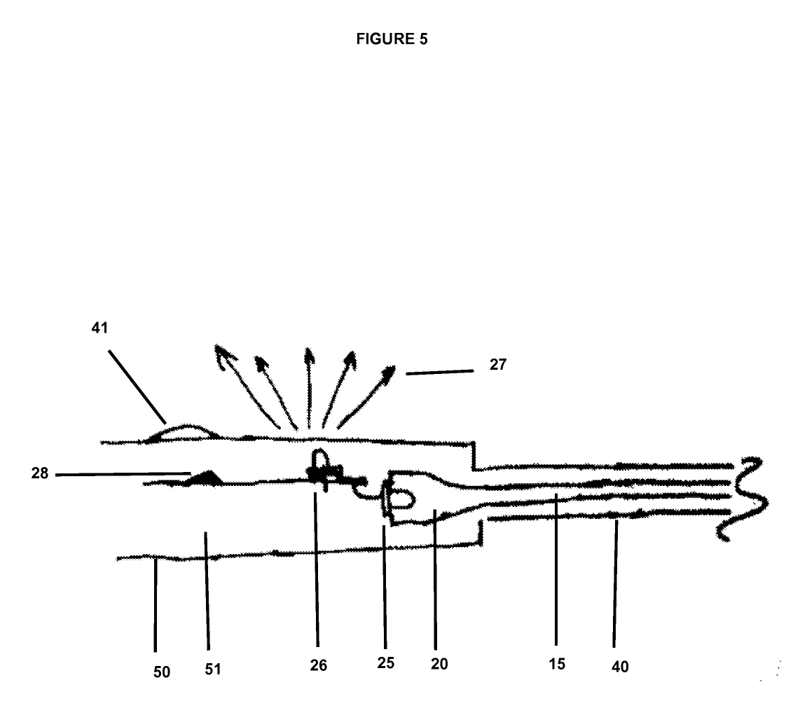

FIG. 5 shows hand grip 50 on handle 51 with light source 25 that directs light into the light concentrating light pipe shallow angle funnel 20 that feeds light into the light pipe and/or fiber optics 15. The light pipe and/or fiber optics 15 is axially located within the body of rod 40. Circuitry 28 is also attached to and controls a second light source 26, which produces light 27 that radially radiates perpendicularly to the axis of rod 40 and handle 51. This light serves as a flashlight that enables the fisherman to read and/or see things near the handle 51. In this embodiment there is a side mount waterproof rubber switch 41 that can control both lights and can also produce a number of different lighting effects controlled by the circuitry 28.

### COMPONENT LIST FOR DRAWINGS

Following is a partial list of the components depicted in the drawings:

| Component Number | Component Description |
|---|---|
| 5 | Illuminated End |
| 10 | Eyelets |
| 15 | Light Pipe and/or Fiber Optic |
| 20 | Light Concentrating Light Pipe Shallow Angle |
| | Funnel |
| 25 | Light Source |
| 26 | Second Light Source |
| 27 | Light from Second Light Source |
| 28 | Circuitry |
| 30 | Means to attach Reel |
| 35 | Waterproof Battery Cap |
| 36 | Waterproof Rubber Switch |
| 37 | Battery Compartment |
| 38 | O Ring |
| 39 | Threads |
| 40 | Rod |
| 41 | Side Mount Waterproof Rubber Switch |
| 42 | Tip |
| 45 | Wires |
| 46 | LED End Lights |
| 50 | Handle Grip |
| 51 | Handle |

### DEFINITIONS

As used herein, the term “and/or,” when used in a list of two or more items, means that any one of the listed items can be employed by itself, or any combination of two or more of the listed items can be employed. For example, if a device is described as containing components A, B, and/or C, the composition can contain A alone; B alone; C alone; A and B in combination; A and C in combination; B and C in combination; or A, B, and C in combination.

What is claimed:

1. A light up fishing rod comprising at least one of the following components:
a handle having at least one of the following:
a sealed waterproof battery compartment that holds at least one battery;
at least one battery holder or caddy (plastic holder for batteries);
a battery cap;
at least one gasket or O ring;
at least one switch;
at least one rubberized waterproof control switch;
at least one of the following:
at least one source of light and at least one means to switch said at least one source of light; and/or
at least one first source of light, at least one second source of light and
at least one means to switch said at least one first source of light and said at least one second source of light;
at least one light concentrating light pipe shallow angle funnel;
at least one circuit;
a means to support and/or attach and/or removeably attach a reel;
a rod having at least one of the following:
at least one eyelet;
at least one additional source of light;
at least one means to conduct power to said at least one additional source of light;
at least one axially oriented light pipe axially transmits light from said at least one source of light throughout the length of said rod, and/or at least one means to radially radiate said light from at least one location along the axial length of said rod;
a permanent and/or removeably attachable flag located at or near the tip of said rod; and/or
at least one axially oriented light pipe that both axially transmits light from said at least one first source of light throughout the length of said rod, and radially radiates said light from said at least one first source of light from at least one location along the axial length of said rod;
at least one attaching means to connect the handle with the rod; and/or
at least one removeably attachable stand to support said light up fishing rod;
wherein said rod, if present, is made from at least one of in whole or in part: fiberglass, composite materials, carbon fiber, wood, metal, plastic, glass, laminated, epoxy, nylon; and/or
wherein said handle, if present, is made from at least one of in whole or in part: foam, cork, rubber, plastic, artificial cork, fiberglass, glass, composite materials, carbon fiber, wood, metal, laminated, epoxy, nylon.

2. The light up fishing rod of claim 1 wherein said battery cap, if present, is a rotating waterproof battery cap.

3. The light up fishing rod of claim 1 wherein said switch, if present, is a soft rubber switch that is water proof and located at the end or tip of the handle.

4. The light up fishing rod of claim 1 wherein said at least one battery, if present, is at least two batteries, which are one of AA or AAA type batteries.

5. The light up fishing rod of claim 1 wherein at least one of the following:
said at least one axially oriented light pipe, if present, is and/or comprises fiber optics;
said at least one means to radially radiate said light from said at least one axial light pipe, if present, is ink internally and/or externally applied to said at least one axial light pipe;
said at least one means to radially radiate said light from said at least one axial light pipe, if present, incorporates at least one irregular surface on said at least one axial light pipe that is at least one of the following: scored, buffed, molded, stamped, after molded, pressed, created with heat;
said at least one means to radially radiate said light from said at least one axial light pipe, if present, is caused and/or facilitated by particles and/or objects embedded within and/or onto said at least one axial light pipe, wherein said particles and/or objects are composed of at least one of the following: reflective materials, solid materials, opaque materials, translucent materials, colored materials, and/or transparent materials with a different index of refraction than that of said at least one axial light pipe;
said at least one source of light, if present, is at least one first source of light and at least one second source of light;
said at least one source of light, if present, is at least one first source of light, at least one second source of light, and at least one of:
the at least two sources of light are two light sources with one of the two light sources located near the handle, and the second of the two light sourced located near tip of rod;
at least one of the two light sources are LEDs or micro LEDS attached and/or soldered to a conduit or wire; and/or
and/or the rod is clear or see-through in areas where LEDs are located;
said at least one first source of light, if present, projects light axially and said at least one second source of light projects light radially;
said circuitry, if present, produces at least two brightness levels of said at least one source of light, wherein said at least two brightness levels includes at least one of the following but not limited to in any order: high, medium, low, off, ability to dim up and/or down and/or fade between levels, blink, fast blink, slow blink, and/or chase of said at least one source of light;
said at least one source of light, if present, is at least one of: LED, incandescent, laser, florescent, and/or electroluminescent;
said at least one second source of light, if present, projects light into said at least one axially oriented light pipe.
said at least one second source of light, if present, is at least one LED located at and/or near the tip of said rod;
said at least one first source of light and/or at least one second source of light, if present, is at least one of LED, incandescent, laser, florescent, electroluminescent;
said rod, if present, further comprises at least one axially oriented light pipe located in at least one portion of said rod that both axially transmits light from said at least one second source of light throughout the length of at least a portion of said rod and at least one means to radially radiate said light from said at least location along the axial length of said rod; and/or
said at least one LED, if present, is a multicolored LED.

6. The light up fishing rod of claim 1 wherein said rod, if present, is at least one of the following: transparent, translucent, opaque, coated, painted.

7. The light up fishing rod of claim 1 wherein, if present, said at least one source of light additionally comprises an adjustable position mechanism or said at least one first source of light additionally comprises an adjustable position mechanism.

8. The light up fishing rod of claim 7 wherein said adjustable position mechanism is one of the following: a rotating turret, and/or a rotatable arm that projects said light at a multiplicity of angles including but not limited to axially down the length of said rod, radially outward and perpendicular to the axis of said rod, or any intermediate angle in between and/or beyond radially outward and perpendicular to the axis of said rod.

9. The light up fishing rod of claim 1 wherein said at least one means to switch said at least one first source of light and said at least one second source of light comprises a first switch to control said at least one first source of light and a second switch to control said at least one second source of light.

10. The light up fishing rod of claim 1 wherein said rod and/or said handle float in water.

11. The light up fishing rod of claim 1 wherein said rod and/or handle is water resistant and/or waterproof.

12. The light up fishing rod of claim 1 is used for at least one of a variety of uses including but not limited to off shore surf casting, as a boat pole, ice fishing, as or as part of tip ups.

13. The light up fishing rod of claim 1 wherein said rod, if present, has a plurality of rod segments interconnectable one to the other by connection means, each connection means being operable to interconnect two adjacent rod segments, and having an electrically conductive portion thereof linked to said at least one circuit to connect said at least one circuit integrally within said rod portion.

14. The light up fishing rod of claim 1 wherein said circuitry produces at least two brightness levels of said at least one source of light.

15. The light up fishing rod of claim 1 wherein said circuitry produces at least two brightness levels of said at least one first source of light and/or said at least one second source of light.

16. The light up fishing rod of claim 1 wherein said at least one means to radially radiate said light from said at least one axial light pipe incorporates at least one irregular surface on said at least one axial light pipe that is at least one of the following: scored, buffed, molded, stamped, after molded, pressed, created with heat.

17. The light up fishing rod of claim 1 wherein said at least one means to radially radiate said light from said at least one axial light pipe is caused and/or facilitated by particles and/or objects embedded within and/or onto said at least one axial light pipe.

18. The light up fishing rod of claim 5 wherein said particles and/or objects are composed of at least one of the following: reflective materials, solid materials, opaque materials, translucent materials, colored materials, and/or transparent materials with a different index of refraction than that of said at least one axial light pipe.

19. The light up fishing rod of claim 5 wherein said at least one second source of light projects light radially and said at least one first source of light projects light radially and/or axially and/or parallel to the axis of said rod.

20. The light up fishing rod of claim 1 wherein said rod is at least one light pipe.
